(19) United States
(12) Patent Application Publication
(10) Pub. No.: US 2011/0303803 A1
(43) Pub. Date: Dec. 15, 2011

(54) SUPPORT STRUCTURE FOR A DISPLAY DEVICE

(76) Inventors: David N. SKINNER, Cupertino, CA (US); Ken Robertson, Los Gatos, CA (US); Peter K. Lee, Cupertino, CA (US); Jacques Gagne, Los Gatos, CA (US); Bruce Eisenhauer, Los Gatos, CA (US)

(21) Appl. No.: 12/816,241

(22) Filed: Jun. 15, 2010

(51) Int. Cl. F16M 11/04

(52) U.S. Cl. 248/122.1

(57) ABSTRACT

A support structure for a display device is disclosed. The support structure may include a main rail configured to attach to the display. The main rail can have a first mating element extending along a portion of the length of the main rail and the main rail has a profile. The support structure also can have a guide member including a second mating element to mate with the first mating element and a friction pad configured to contact the curved profile.

### BACKGROUND

Computer monitors and display devices in general have support structures that allow for limited movement. They generally allow minimal vertical travel or a small amount of tilting and do not provide for a large amount of both vertical and angular adjustments.

### BRIEF DESCRIPTION OF THE DRAWINGS

The present disclosure will be described with reference to the following drawings, wherein:

FIG. 1 shows a side view of an embodiment of a support structure for a display device, with the display device in its upright position.

FIG. 2 shows a rear view of an embodiment of a support structure for a display device, with the display device in its upright position.

FIG. 3 shows a side view of an embodiment of a support structure for a display device, with the display device in its reclined position.

FIG. 4 shows a side view of another embodiment of a support structure for a display device.

FIG. 5 shows a side view of another embodiment of a support structure for a display device.

FIG. 6 shows the position of a main rail with respect to a guide member of an embodiment of a support structure for a display device in its upright position.

FIG. 7 shows the position of a main rail with respect to a guide member of an embodiment of a support structure for a display device in its reclined position.

FIG. 8 shows a guide member of an embodiment of a support structure for a display device.

FIG. 9 shows a leaf spring of a guide member of an embodiment of a support structure for a display device.

FIG. 10 shows a main rail positioned in a guide member of an embodiment of a support structure for a display device.

### DETAILED DESCRIPTION

The following description as exemplified by the drawings is illustrative and is not intended as any limitation of the claims of this application. A support structure for a display device, for example, a personal computer monitor is disclosed herein. The support structure creates a smooth movement of the display along a generally curved path between a generally vertical position and a generally reclined position with respect to the vertical. A smooth movement of the display occurs when there is not a substantial increase in the amount of force that the user has to apply when moving the display to any position.

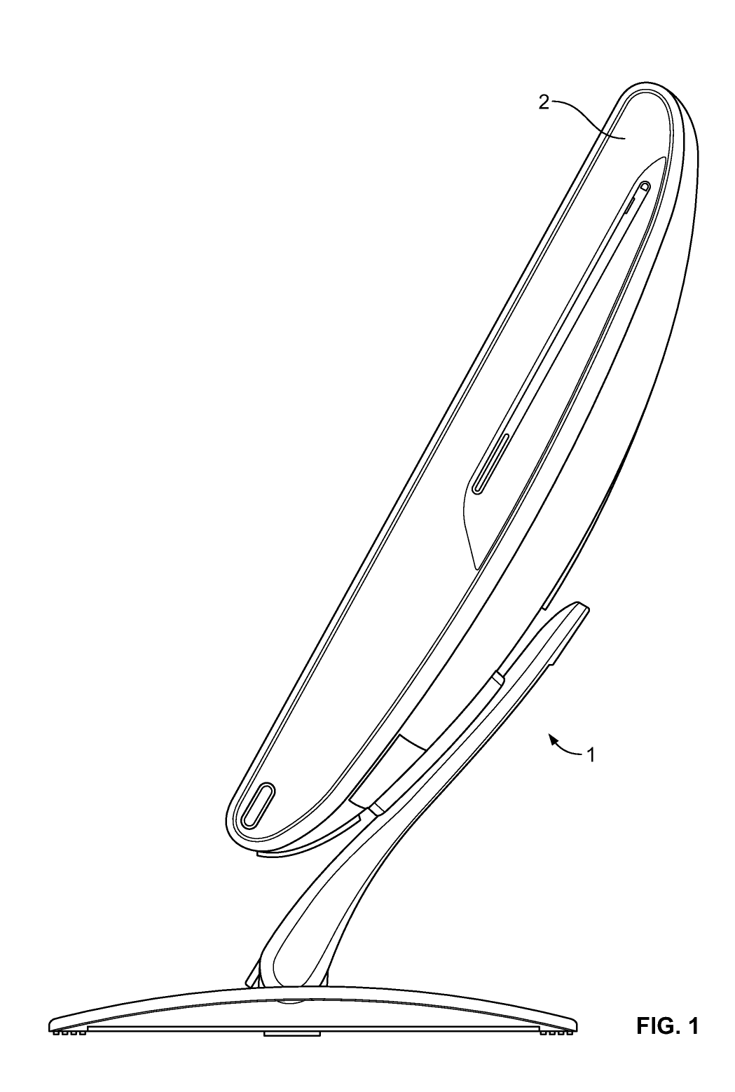

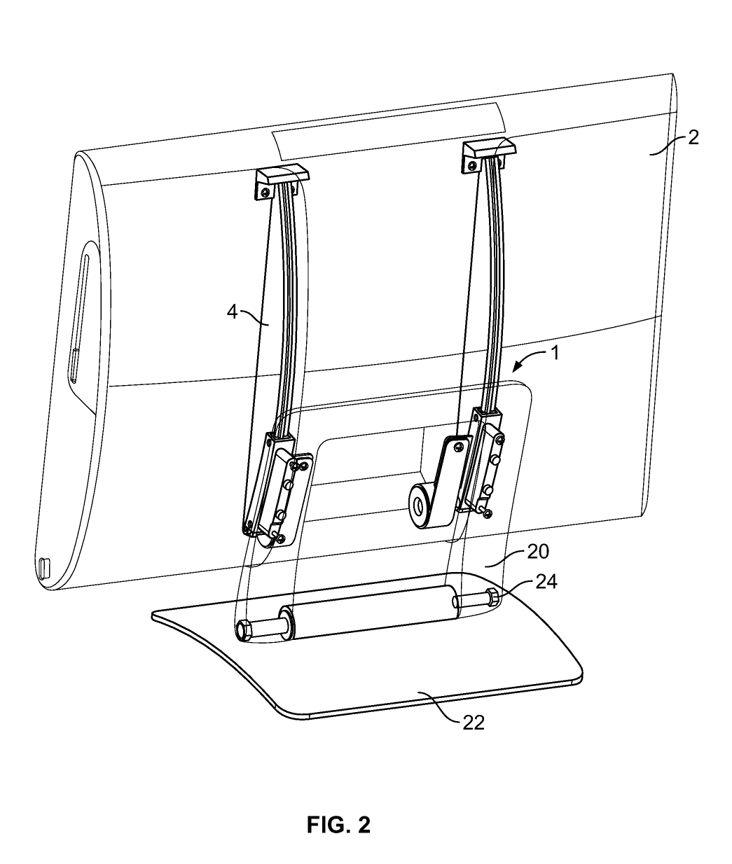

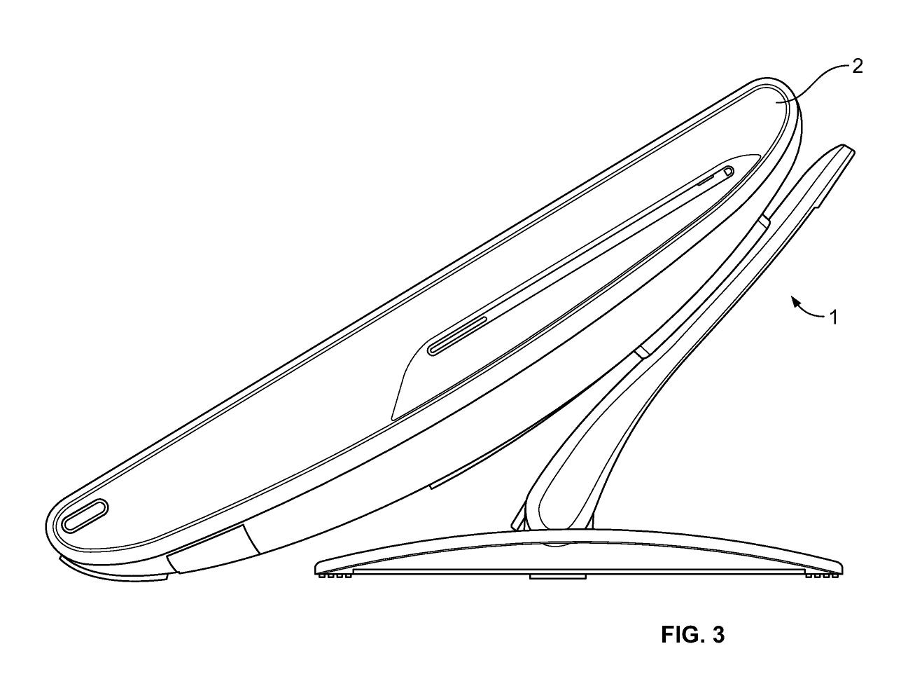

As illustrated generally in FIGS. 1-3, an embodiment of a support device 1 is shown that allows a display device 2 to travel between a generally upright position shown in FIGS. 1 and 2 and a generally reclined position shown in FIG. 3. Attached to the display device 2 is a main rail 4. Although two main rails are illustrated in FIG. 3, one may also be used.

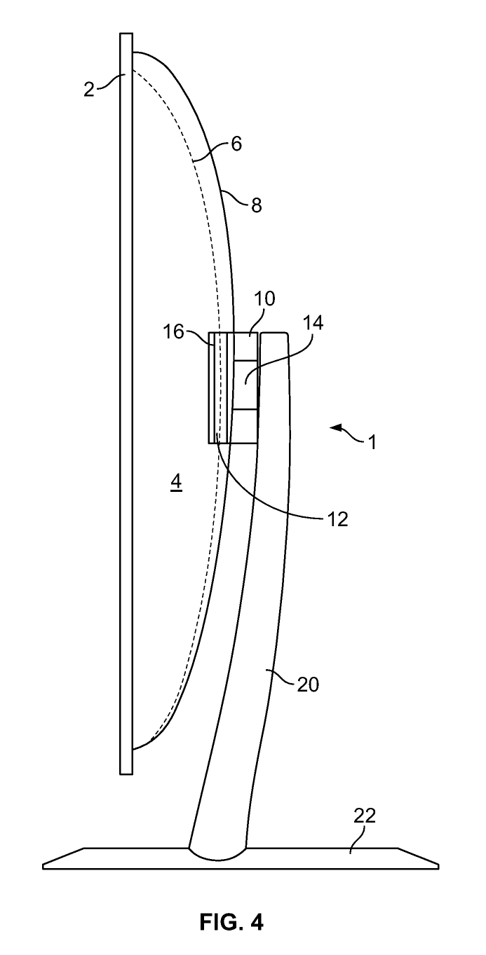

As shown in side view in FIG. 4, the main rail 4 has a first mating element 6 extending along a path at least a portion of its length. The first mating element 6 may form a curved path or arc as shown by the dotted line. The curved path formed by the first mating element 6 may have a constant radius or it may have a variable radius. The main rail also has a profile. The profile may be a curved profile 8 that may have a constant radius or may have a variable radius. If the curved path of the first mating element were to have a constant radius, then the curved profile may have a variable radius. On the other hand, if the curved path of the first mating element were to have a variable radius, then the curved profile may have a constant radius.

As shown in FIG. 4, an embodiment of the support structure may have a guide member 10. The guide member 10 has a second mating element 12 that is configured to mate with the first mating element 6 of the main rail 4. The first and second mating elements form a guide for the transit of the main rail in the guide member for allowing the display device to move between a generally vertical position and a generally reclined position. The first mating element 6 may be female, in which a slot or track may be formed in the main rail. When the first mating element is female, the second mating element 12 of the guide member 10 would be male. A male mating element 12 of a guide member may be a protrusion from the guide member for fitting into a portion of the slot or track of the main rail. In another embodiment, the first mating element 6 of the main rail may be male, in which a protrusion extends from the main rail. When the first mating element 6 is male, the second mating element 12 of the guide member would be female. A female mating element 12 of a guide member may be a slot or channel within the guide member for receiving an extending protrusion from the main rail.

As further shown in FIG. 4, the guide member 10 may include a friction pad 14. The friction pad is configured to contact the curved profile 8 and to provide friction with the curved profile as the curved profile moves through the guide member while still providing smooth movement of the display.

A biasing element 16 may be positioned within the guide member. The biasing element may be configured to be compressed between the guide member and the main rail. In one embodiment, the biasing element may be positioned between the guide member and the length of the main rail 4. The biasing element may be a leaf spring that is connected to the first mating element, to the second mating element, to the main rail, or to the guide member. The biasing element in such an embodiment may laterally flex between the main rail and the guide member to accommodate any variance in the distance between the main rail and the guide member. For example, as the display device is moved between an upright position and a reclined position, there may be a tolerance that may be taken up by the biasing element 16. By absorbing such a tolerance, smooth movement of the display device may be provided. An example of such a tolerance between the mating elements along the length of the main rail may be about 0.8 mm. By accommodating for this tolerance by using a biasing device, racking of the display device as it is moved may be generally avoided while still providing smooth movement. Racking of the display device may occur when one side of the display device does not travel in a path parallel with the other side of the display device.

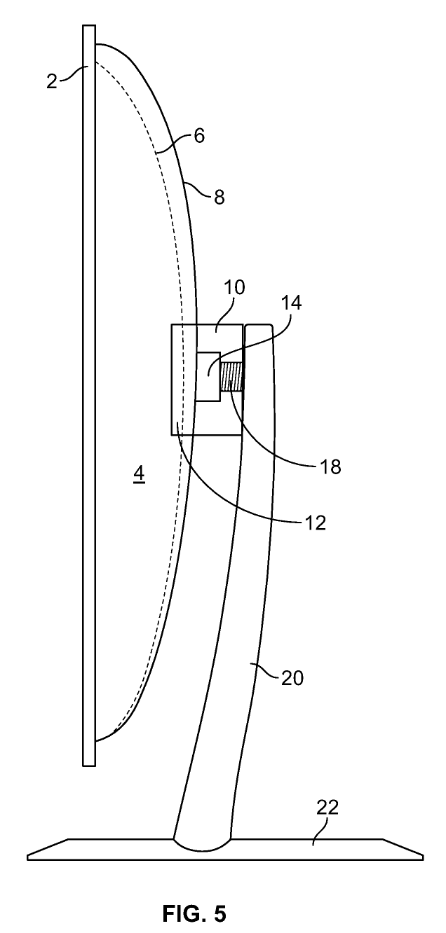

Another embodiment of a support structure for a display device is illustrated in side view in FIG. 5. In this embodiment, the guide member 10 may have a biasing element 18 positioned so as to urge the friction pad 14 upon the curved profile 8. In this embodiment, a leaf spring may not be used if the tolerances between the guide member and the main rail prevent the racking of the display device as the friction pad is urged upon the curved profile creating a force as the biasing element 18 is compressed. The biasing element 18 may be in the form of a coiled spring.

As illustrated in the embodiments shown in FIGS. 4 and 5, by having the curved path or arc formed by the first mating element different from the curve formed by the curved profile 8, a variable amount of friction may be applied between the curved profile and the friction pad when the main rail moves within the guide member. For example, the first mating element may form a curve having a constant radius and the curve formed by the curved profile may be of a non-constant radius. In this way, a varying amount of friction may be designed to be applied between the guide member and the main rail as the display moves between its upright position and its reclined position. Having a varying amount of friction holds the amount of force that the user has to apply to move the display relative to the base constant, even though moving the center of gravity of the display device causes the weight distribution to change relative to the base.

As a still further embodiment, the guide member may include the biasing element 16 in addition to the biasing element 18.

As generally shown in FIGS. 1-5, the guide member 10 may be attached to a bracket 20 extending from a base 22. In one embodiment, as specifically shown in FIG. 2, the bracket 20 may be attached to the base 22 by a pivotal attachment 24.

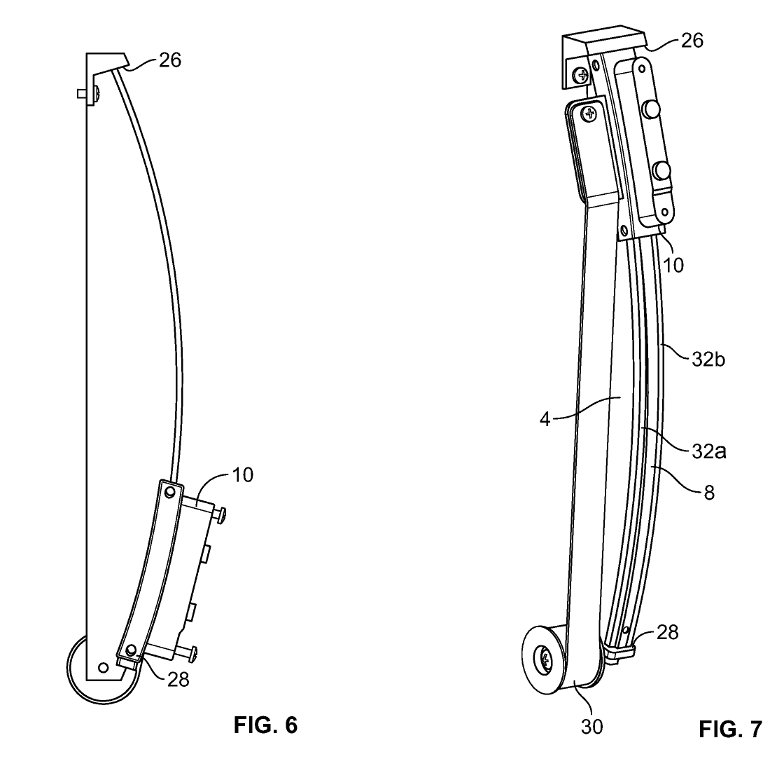

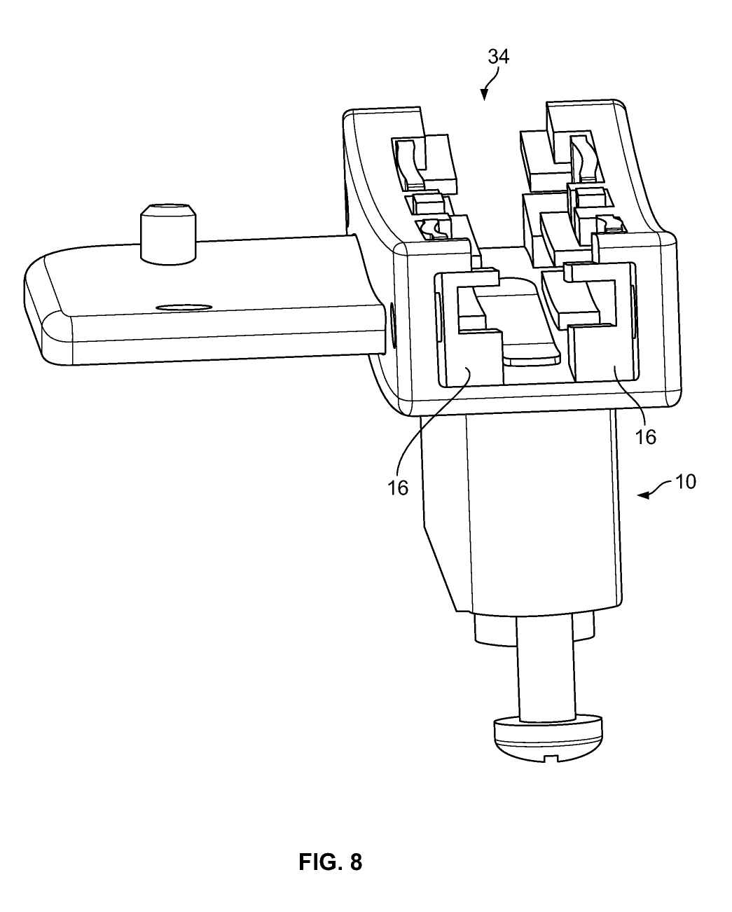

As illustrated in FIGS. 6 and 7, a first stop 26 may be provided at an end of the main rail thus preventing the display device to travel beyond its most reclined position by stopping the transit of the main rail through the guide member. For example, in the reclined position the display device may be at about a 30° degree angle to the base. Similarly, a second stop 28 may be provided at an opposite end of the main rail thus preventing the display device to travel beyond its most upright position. For example, in the upright position the display device may be at about a 90° to the base. As shown in FIGS. 6 and 7, the stops 26 and 28 prevent the main rail 4 from traveling through the guide member 10 beyond these positions.

As shown in FIG. 7, another embodiment of a support structure may include a second biasing device 30. The second biasing device 30 may extend between the main rail 4 and the guide member 10 and be configured to provide tension therebetween. Providing such tension may aid the user when moving the display between its upright and reclined positions. An example of the second biasing element may be a constant force spring such as a negator spring. The second biasing element may help to support the weight of the display so that the forces applied by the users of the support structure, for example, about 2 kg, are minimized.

In one embodiment of the support structure, the main rail may have the male first mating element in the form of a wing rail. Another embodiment, as illustrated in FIG. 7 may have a pair of wing rails 32a and 32b. The curved profile 8 may extend from the wing rails thereby creating a cruciform cross-section of the main rail 4. As shown in FIG. 7, each wing rail 32a and 32b is on opposite sides of the main rail. The wing rails may extend generally perpendicularly from the length of the main rail and form a curve or arc having a generally constant radius. The curved profile 8, having a non-constant radius may be configured to increase the friction non-linearly upon the friction pad. Of course, a non-linear application of friction may also be applied by the friction pad upon the curved profile by having the curve formed by the wing rails be a non-constant radius and having the curved profile form a curve having a constant radius. For example, the distance from the wing rail to the surface of the profile where the friction pad contacts the profile may vary between 0 and 10 mm.

An embodiment of the guide member 10 is illustrated in FIG. 8. If the main rail were to have a cruciform cross section as described above, then the guide member would have a corresponding cruciform shaped interior recess 34 for generally conforming to the cruciform cross-section of the main rail. As illustrated in FIG. 8, an embodiment of the biasing element 16 is shown. In particular, a pair of leaf springs 16 are illustrated positioned within the recess 34 opposite one another. Each of the leaf springs provide bias between the guide member and the main rail when the main rail is within the guide member. By having leaf springs so positioned, they may be configured to flex toward each other. Thus, a smooth motion to the display may be provided while minimizing any racking effect produced by rails moving through guide members.

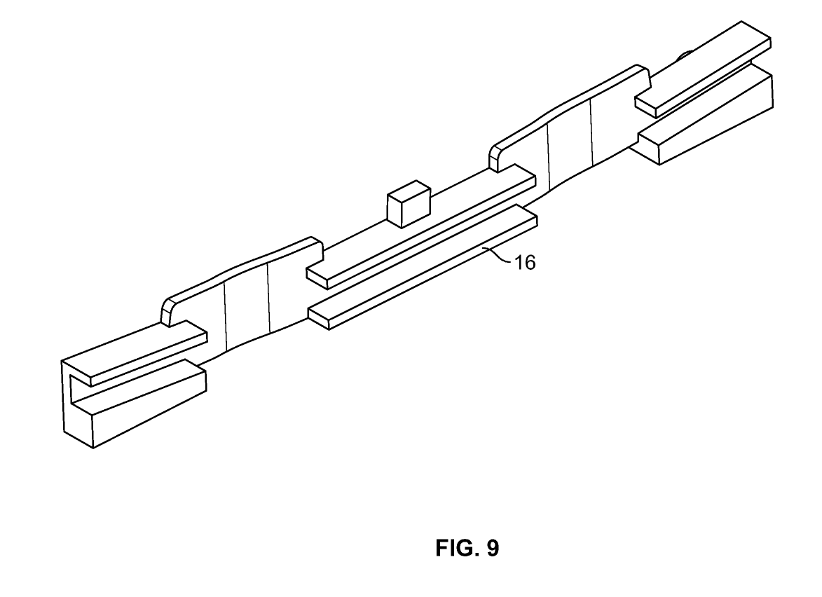

A drawing of an embodiment of a leaf spring is shown in FIG. 9.

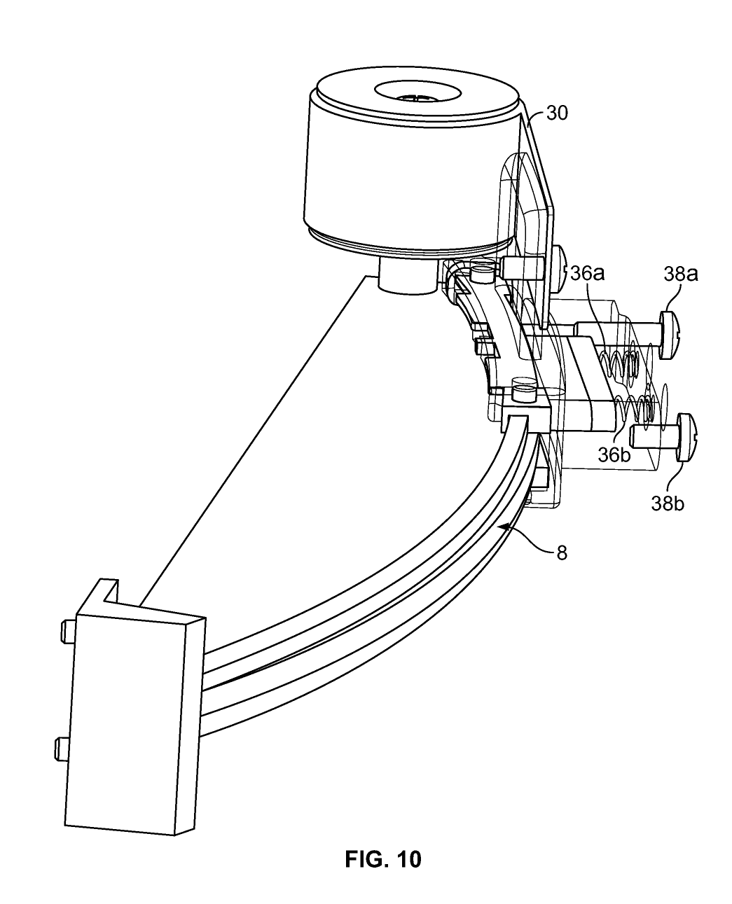

As shown in FIG. 10, an embodiment of a support structure may have a guide member 10 that has the first biasing element in the form of a pair of coiled springs 36a and 36b interposed between the friction pad 14 and the guide member to control the force applied by the friction pad upon the curved profile 8. Such an embodiment may also include an adjustment screw positioned within the coils of the coiled spring. By positioning an adjustment screw in the coils of the coiled spring the compression of the coiled spring may be adjusted. As shown in FIG. 10, each coiled spring 36a and 36b has a corresponding adjustment screw 38a and 38b to be positioned in the coils of the coiled springs. Such an adjustment screw may be used to adjust the amount of force applied to the friction pad by the coiled springs.

In operation, the main rail is attached to the display and rides within the guide members providing the desired travel of the display. When the screen is at its most upright position, the frictional force between the friction pad and the curved profile rail may be configured to be at its highest because of the difference between the curve of the first mating element and the curve of the curved profile. As another example, the frictional force may be tuned by the particular curve of the profile of the curved profile rail and the curve of the first mating element. Of course, the frictional force may be designed to change in a different manner along the travel path of the device depending upon specific designs. The result of the application of a variable frictional force during the travel of the display, which may be coupled with the addition of the second biasing element, allows a consistent feel to the user regardless of the display position.

Although the particular embodiments shown and described above will prove to be useful in many applications in the supporting structure art, further modifications will occur to persons skilled in the art. All such modifications are deemed to be within the scope and spirit of the appended claims.

What is claimed is:

1. A support structure for a display device, comprising:
a main rail configured to attach to the display, wherein the main rail has a first mating element extending along a portion of the length of the main rail in a path, and wherein the main rail has a profile;
a guide member having a second mating element configured to mate with the first mating element, and a friction pad configured to contact the curved profile; and
a first biasing element operable to apply force between the guide member and the main rail.

2. The support structure of claim 1, wherein the path of the first mating element is a curved path, the profile is a curved profile, and wherein the first biasing element is operable to urge the friction pad upon the curved profile.

3. The support structure of claim 2, wherein the first biasing element is a coiled spring and further comprising an adjustment screw positioned in the coils of the coiled spring operable to adjust the compression thereof.

4. The support structure of claim 2, wherein the main rail has a length, and further comprising a second biasing element positioned between the guide member and the length of the main rail.

5. The support structure of claim 1, wherein the path of the first mating element is a curved path, the profile is a curved profile, and wherein the curved path of the first mating element has a curve of a different radius than the curve of the curved profile.

6. The support structure of claim 5, wherein the curved path of the first mating element has a curve of a substantially constant radius and wherein the curve of the curved profile has a variable radius.

7. The support structure of claim 5, wherein the curved path of the first mating element has a curve of a variable radius and wherein the curve of the curved profile has a substantially constant radius.

8. The support structure of claim 1, wherein the first biasing element is positioned between the guide member and the length of the main rail.

9. The support structure of claim 8, wherein the first biasing element is a leaf spring.

10. The support structure of claim 1, wherein the first mating element is male and the second mating element is female.

11. The support structure of claim 10, wherein the first mating element is a wing rail extending outwardly from the main rail and the second mating element is a recess within the guide member configured to receive the wing rail.

12. The support structure of claim 1, wherein the first mating element is female and the second mating element is male.

13. The support structure of claim 12, wherein the first mating element is a track in the main rail and the second mating element is a protrusion within the guide member configured to extend into a portion of the track.

14. The support structure of claim 1, further comprising a second biasing element extending between the main rail and the guide member operable to provide tension therebetween.

15. A support structure for a display device, comprising:
a base;
a bracket pivotably attached to the base and extending therefrom;
a guide member attached to the bracket having a first mating element and a friction pad therein;
a main rail having a second mating element configured to mate with the first mating element of the guide member, wherein the main rail has a curved profile and wherein the main rail is configured to move along an arc defined by the first and second mating elements; and
a first biasing element positioned in the guide member operable to urge the friction pad upon the curved profile.

16. The support structure of claim 15, wherein the arc has a different radius than the curve of the curved profile.

17. The support structure of claim 16, wherein the arc has a substantially constant radius and the curved profile has a variable radius.

18. The support structure of claim 16, wherein the arc has a variable radius and the curved profile has a substantially constant radius.

19. The support structure of claim 15, further comprising a second biasing element positioned between the guide member and the length of the main rail, wherein the first biasing element is a coiled spring and further comprising an adjustment screw positioned in the coils of the coiled spring operable to adjust the compression thereof.

20. The support structure of claim 19, further comprising a third biasing element extending between the guide member and the main rail operable to provide tension therebetween.
